(19) United States
(12) Patent Application Publication
(10) Pub. No.: US 2026/0051302 A1
(43) Pub. Date: Feb. 19, 2026

(54) METHOD AND MANAGEMENT APPARATUS FOR MANAGING EXTENDED DISPLAY IDENTIFICATION DATA

(71) Applicant: ADVANTECH CO., LTD., Taipei (TW)

(72) Inventors: Kuan-Chieh HSU, Taipei (TW); Chia-Wen HSIAO, Taipei (TW)

(21) Appl. No.: 19/097,446

(22) Filed: Apr. 1, 2025

(30) Foreign Application Priority Data
Aug. 19, 2024 (TW) 113131121

(51) Int. Cl. G09G 5/00

(52) U.S. Cl. CPC G09G 5/003; G09G 2370/042

(57) ABSTRACT

A method of managing EDID is implemented by a management apparatus that is connected to a chip module and a display. The management apparatus includes an MCU, an IO interface and a storage medium. The IO interface includes a connection port adapted to be connected to the display and associated with the storage medium. The display stores EDID related to itself. The method includes steps of: the MCU obtaining the EDID from the display; the MCU storing the EDID in the storage medium that is associated with the connection port which the display is connected to; and the MCU generating and sending a notification signal that is related to the storage medium to the chip module, so that the chip module obtains the EDID from the storage medium based on the notification signal, and controls the display that corresponds to the storage medium to display content based on the EDID.

### CROSS-REFERENCE TO RELATED APPLICATION

This application claims priority to Taiwanese Invention Patent Application No. 113131121, filed on Aug. 19, 2024, the entire disclosure of which is incorporated by reference herein.

### FIELD

The disclosure relates to a method and an apparatus for managing data for a display, and more particularly to a method and a management apparatus for managing extended display identification data (EDID) for a display.

### BACKGROUND

Referring to FIG. 1, a conventional architecture for multiple displays is exemplified to include a plurality of displays 9 (e.g., four), and a central processing unit (CPU) 8 that is electrically connected to the displays 9. In order for the CPU 8 to obtain, from each of the displays 9, extended display identification data (EDID) that indicates resolution for the display 9, and to generate and send display data to the display 9 based on the EDID, the CPU 8 must be from a specific brand (e.g., Intel Corporation) and be operated under a specific operating system (e.g., Microsoft Windows). Specifically, for each of the displays 9, the CPU 8 is configured to store the EDID of the display 9, and associate (i.e., interlock) the EDID with the display 9, so that when one of the displays 9 is adjusted or disconnected, the remaining displays 9 would not be affected.

However, in the conventional architecture, if the CPU 8 is not from the specific brand (e.g., from another brand such as Advanced Micro Devices, Inc. (AMD)), the CPU 8 may not be able to interlock the EDID with the corresponding display 9. As a result, when one of the displays 9 is adjusted or disconnected, the remaining displays 9 may be affected and may display content incorrectly (as exemplified in FIG. 2).

### SUMMARY

Therefore, an object of the disclosure is to provide a method and a management apparatus for managing extended display identification data (EDID) that can alleviate at least one of the drawbacks of the prior art.

According to an aspect of the disclosure, a method of managing EDID is to be implemented by a management apparatus that is adapted to be connected to a chip module and a display. The management apparatus includes a microcontroller (MCU), an input/output (IO) interface and a storage medium. The IO interface includes a connection port that is adapted to be connected to the display and that is associated with the storage medium. The display stores EDID related to itself. The method includes steps of: the MCU obtaining the EDID from the display; in response to obtaining the EDID, the MCU storing the EDID in the storage medium that is associated with the connection port which the display is connected to; and after storing the EDID in the storage medium, the MCU generating and sending a notification signal to the chip module, where the notification signal is related to the storage medium, so that the chip module obtains the EDID from the storage medium based on the notification signal, and controls the display that corresponds to the storage medium to display content based on the EDID.

According to another aspect of the disclosure, a management apparatus for managing EDID is adapted to be connected to a chip module and a display that stores EDID related to itself. The management apparatus includes a storage medium, an input/output (IO) interface and a microcontroller (MCU). The IO interface includes a connection port that is adapted to be connected to the display and that is associated with the storage medium. The MCU is configured to obtain the EDID from the display, and in response to obtaining the EDID, store the EDID in the storage medium that is associated with the connection port which the display is connected to. The MCU is further configured to, after storing the EDID in the storage medium, generate and send a notification signal to the chip module, where the notification signal is related to the storage medium. As a result, in response to receiving the notification signal from the MCU, the chip module obtains the EDID from the storage medium based on the notification signal, and controls the display that corresponds to the storage medium to display content based on the EDID.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram of a conventional architecture for multiple displays.

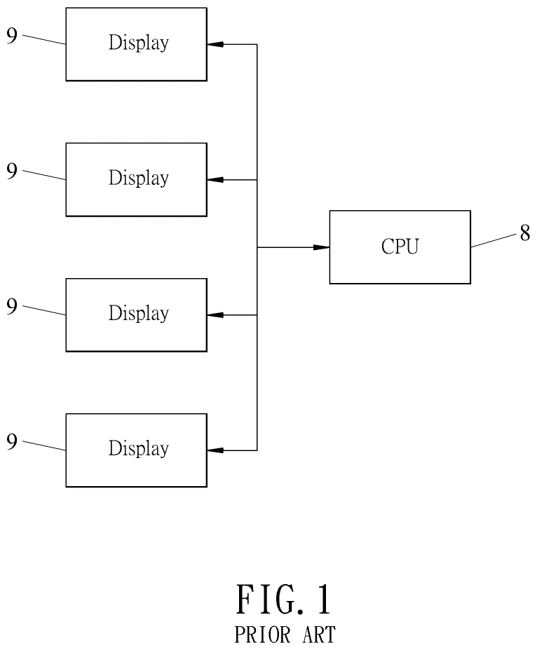

FIG. 2 is a schematic diagram illustrating content displayed by four displays.

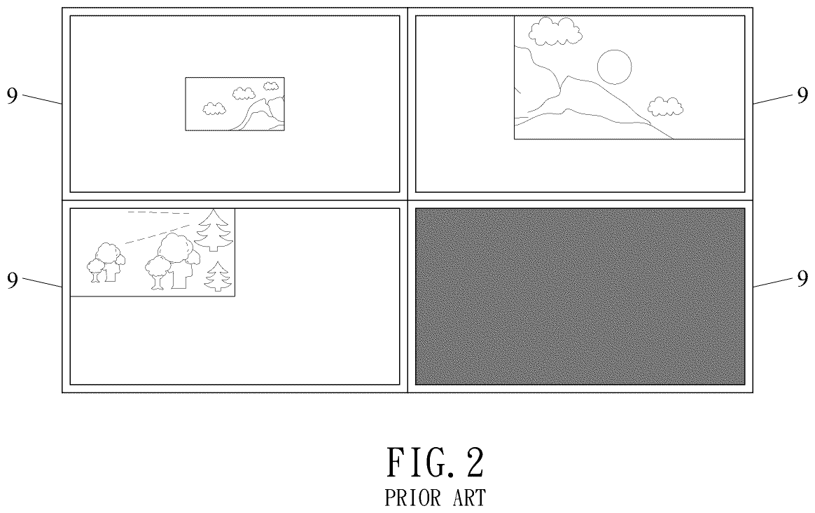

FIG. 3 is a block diagram of a management apparatus according to an embodiment of the disclosure.

FIG. 4 is a flow chart of a method for managing EDID according to an embodiment of the disclosure.

FIG. 5 is a schematic diagram illustrating content displayed by four displays according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

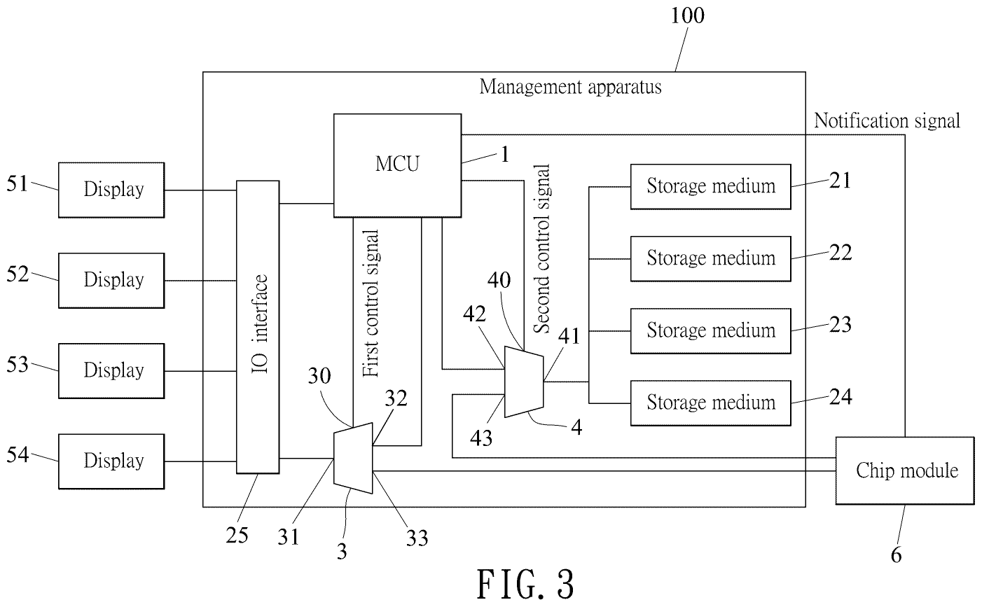

Referring to FIG. 3, a management apparatus 100 for managing EDID according to an embodiment of the disclosure is provided. The management apparatus 100 is electrically connected to a chip module 6 and a plurality of displays (e.g., four displays 51-54). Each of the displays 51-54 stores EDID that is related to resolution, a brand name and a clock rate of itself. The management apparatus 100 includes a microcontroller (MCU) 1, a plurality of storage mediums (e.g., four storage mediums 21-24), an input/output (IO) interface 25, a first multiplexer 3 and a second multiplexer 4. Each of the storage mediums 21-24 may be implemented using one or more of random access memory (RAM), read only memory (ROM), programmable ROM (PROM), firmware, flash memory, electrically-erasable programmable read-only memory (EEPROM), etc. The chip module 6 includes a central processing unit (CPU, not shown) and a memory unit (e.g., RAM, ROM, PROM, flash memory, EEPROM, not shown) that is electrically connected to the CPU.

The MCU 1 is electrically connected to the displays 51-54 through the IO interface 25, and is configured to determine whether an EDID lock setting is enabled or disabled, and to operate accordingly. Specifically, when the EDID lock setting is enabled, the EDID of each of the displays 51-54 is obtained and stored by the MCU 1 to one of the storage mediums 21-24 that corresponds to the display, and the MCU 1 notifies the chip module 6 to obtain the EDID of each of the displays 51-54 from the corresponding storage medium 21-24 for controlling the displays 51-54 to display content. When the EDID lock setting is disabled, the EDID of each of the displays 51-54 is directly obtained and processed by the chip module 6 for controlling the displays 51-54 to display content. It should be noted that the EDID lock setting may be adjusted by a user through a BIOS (Basic Input/Output System) setting menu.

Each of the storage mediums 21-24 is electrically connected to the MCU 1 and is configured to store the EDID of one of the displays 51-54. In one example, the IO interface 25 includes four connection ports that are respectively adapted to be connected to the displays 51-54 and that are respectively associated with the storage mediums 21-24. In such a case, each of the storage mediums 21-24 is configured to store the EDID of the corresponding one of the displays 51-54 that is connected to the respective one of the connection ports. That is to say, assuming that the display 51 is connected to one of the connection ports that is associated with the storage medium 21, and then the EDID of the display 51 is stored in the storage medium 21, but the disclosure is not limited to the abovementioned example.

The first multiplexer 3 is electrically connected among the MCU 1, the displays 51-54 and the chip module 6. Specifically, the first multiplexer 3 includes a first end 31 electrically connected to the displays 51-54 through the IO interface 25, a second end 32 electrically connected to the MCU 1, a third end 33 electrically connected to the chip module 6, and a selection line 30 for receiving a first control signal from the MCU 1. The first multiplexer 3 is configured to be controlled by the first control signal that is generated by the MCU 1 to switch between an interface-MCU connection and an interface-chip connection, where the interface-MCU connection establishes a connection between the IO interface 25 and the MCU 1 for signal transmission, and the interface-chip connection establishes a connection between the IO interface 25 and the chip module 6 for signal transmission. To describe in further detail, the interface-MCU connection establishes a connection for signal transmission between the first end 31 and the second end 32 of the first multiplexer 3, and the interface-chip connection establishes a connection for signal transmission between the first end 31 and the third end 33 of the first multiplexer 3.

The second multiplexer 4 is electrically connected among the MCU 1, the storage mediums 21-24 and the chip module 6. Specifically, the second multiplexer 4 includes a first end 41 electrically connected to the storage mediums 21-24, a second end 42 electrically connected to the MCU 1, a third end 43 electrically connected to the chip module 6, and a selection line 40 for receiving a second control signal from the MCU 1. The second multiplexer 4 is configured to be controlled by the second control signal that is generated by the MCU 1 to switch between an MCU-storage connection and a storage-chip connection, where the MCU-storage connection establishes a connection between the MCU 1 and the storage mediums 21-24 for signal transmission, and the storage-chip connection establishes a connection between the storage mediums 21-24 and the chip module 6 for signal transmission. To describe in further detail, the MCU-storage connection establishes a connection for signal transmission between the first end 41 and the second end 42 of the second multiplexer 4, and the storage-chip connection establishes a connection for signal transmission between the first end 41 and the third end 43 of the second multiplexer 4.

In this embodiment, the first control signal and the second control signal may be transmitted using a general-purpose input/output (GPIO) port of the MCU 1. In one example, the MCU 1 has eight GPIO ports (not shown), and the first control signal is transmitted using the first to the fourth GPIO ports of the MCU 1, and the second control signal is transmitted using the fifth to the eighth GPIO ports of the MCU 1, where each of the first control signal and the second control signal is implemented using one-hot coding, binary coding, or Gray coding, but the disclosure is not limited to such.

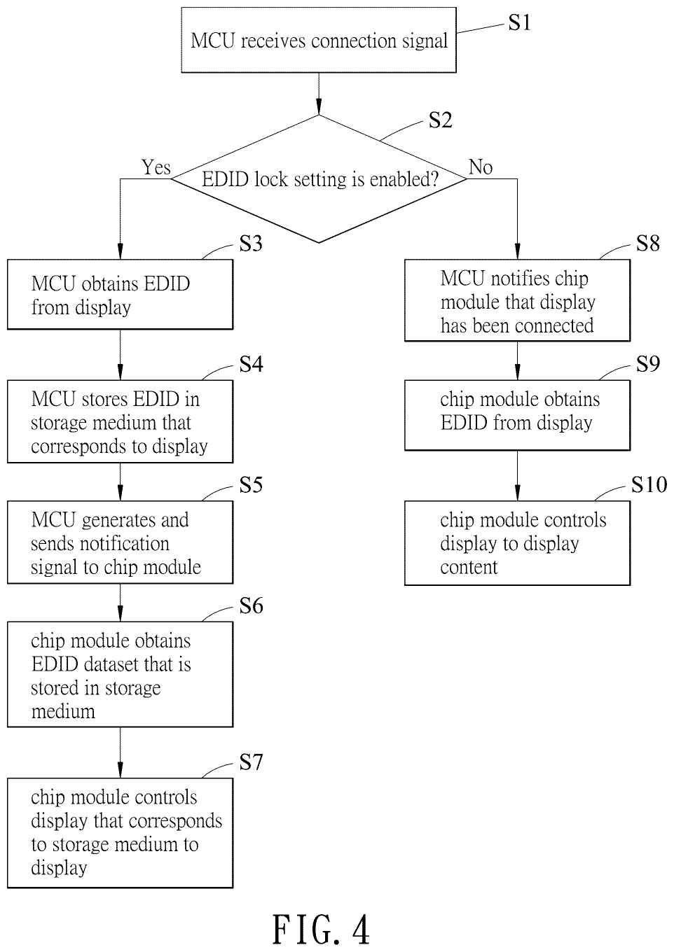

Referring to FIG. 4, a method of managing EDID according to an embodiment of the disclosure is implemented by the management apparatus 100. The method includes steps S1 to S10. In the following description, since the EDID of the displays 51-54 and the corresponding storage mediums 21-24 are handled by the MCU 1 in a similar manner, only the display 51 and the corresponding storage medium 21 are described in detail for simplicity.

In step S1, the MCU 1 receives a connection signal from the IO interface 25, where the connection signal is outputted by one of the connection ports of the IO interface 25 upon a display (e.g., the display 51) being connected to the one of the connection ports of the IO interface 25. In this embodiment, the connection signal is a hot-plug detect (HPD) signal, and the MCU 1 determines which connection port is connected to the display 51 by identifying a source of the connection signal.

In step S2, in response to receiving the connection signal, the MCU 1 determines whether the EDID lock setting is enabled. If the determination in step S2 is affirmative, a flow of the method proceeds to step S3; otherwise, the flow proceeds to step S8.

In step S3, in response to determining that the EDID lock setting is enabled, the MCU 1 obtains the EDID from the display 51. To describe in further detail, the MCU 1 generates the first control signal to indicate the interface-MCU connection between the IO interface 25 and the MCU 1, and sends the first control signal to the first multiplexer 3. In response to receiving the first control signal that indicates the interface-MCU connection, the first multiplexer 3 establishes the interface-MCU connection between the IO interface 25 and the MCU 1. Then, the MCU 1 obtains the EDID from the display 51 through the interface-MCU connection.

In step S4, in response to obtaining the EDID, the MCU 1 stores the EDID in the storage medium 21 that is associated with the connection port which the display 51 is connected to (i.e., the MCU 1 stores the EDID of the display 51 in the corresponding storage medium 21), and the flow proceeds to step S5. To describe in further detail, the MCU 1 generates the second control signal to indicate the MCU-storage connection between the MCU 1 and the storage medium 21, and sends the second control signal to the second multiplexer 4. In response to receiving the second control signal that indicates the MCU-storage connection, the second multiplexer 4 establishes the MCU-storage connection between the MCU 1 and the storage medium 21. Then, the MCU 1 generates an EDID dataset to include the EDID and an address that indicates a storing location of the EDID in the storage medium 21 (e.g., an EEPROM), and transmits the EDID dataset to the storage medium 21 according to the address through the MCU-storage connection, so as to store the EDID dataset in the storage medium 21. It should be noted that the storing location of the EDID is defined by the EDID specifications, and is for the MCU 1 and/or the chip module 6 to read/write the EDID from/into the storage medium 21.

Specifically, the MCU 1 stores a processing program that, when executed by the MCU 1, causes the MCU 1 to perform an overwriting procedure, a locking procedure, and/or a reading procedure. The overwriting procedure is for deleting data from one of the storage mediums 21-24, and then storing data in the one of the storage mediums 21-24. The locking procedure is for preventing the data stored in one of the storage mediums 21-24 from being tampered with. The reading procedure is for reading data from one of the storage mediums 21-24. In step S4, the MCU 1 stores the EDID dataset in the storage medium 21 by performing the overwriting procedure and then the locking procedure through executing the processing program that is stored in the MCU 1. As such, the EDID dataset that is related to each of the displays 51-54 is interlocked with its corresponding one of the storage mediums 21-24. In one example, the storage medium 21 is associated with one of the connection port which the display 51 is connected to, and thus the EDID dataset related to the display 51 is stored in and interlocked with the storage medium 21. Similarly, the storage medium 22 stores the EDID dataset related to the display 52, the storage medium 23 stores the EDID dataset related to the display 53, and the storage medium 24 stores the EDID dataset related to the display 54, but the disclosure is not limited to such.

In step S5, the MCU 1 generates and sends a notification signal that is related to the storage medium 21 to the chip module 6, and the flow proceeds to step S6. In this embodiment, the notification signal is an HPD signal. To describe in further detail, the MCU 1 generates the second control signal to indicate the storage-chip connection between the storage medium 21 and the chip module 6, and sends the second control signal to the second multiplexer 4. In response to receiving the second control signal that indicates the storage-chip connection, the second multiplexer 4 establishes the storage-chip connection between the storage medium 21 and the chip module 6. The MCU 1 further generates the first control signal to indicate the interface-chip connection between the IO interface 25 and the chip module 6, and sends the first control signal to the first multiplexer 3. In response to receiving the first control signal that indicates the interface-chip connection, the first multiplexer 3 establishes the interface-chip connection between the IO interface 25 and the chip module 6. In some embodiments, the interface-chip connection may be established simultaneously with the storage-chip connection, or may be established one after another, but the disclosure is not limited to such. After sending the first control signal and the second control signal to the first multiplexer 3 and the second multiplexer 4, respectively, the MCU 1 generates and sends the notification signal to the chip module 6.

In step S6, in response to receiving the notification signal that is related to the storage medium 21 from the MCU 1, the chip module 6 obtains the EDID dataset that is stored in the storage medium 21 based on the notification signal through the storage-chip connection, and the flow proceeds to step S7. In this embodiment, the chip module 6 obtains the EDID dataset and stores the EDID dataset in the memory thereof. In one example, when four displays (e.g., the displays 51-54) are all connected to the IO interface 25 so that the EDID of each of the displays is stored in the corresponding storage medium, the MCU 1 generates and sends four notification signals to the chip module 6 in step S5, so that in step S6, the chip module 6 obtains the EDID datasets respectively of the displays 51-54 from the corresponding storage mediums 21-24, respectively. It should be noted that the four notification signals are related respectively to the storage mediums 21-24, and are further related respectively to the displays 51-54.

In step S7, the chip module 6 controls, through the interface-chip connection, the display 51 that corresponds to the storage medium 21 (i.e., the display 51 that is related to the notification signal) to display content based on the EDID dataset. In this embodiment, the display 51 is controlled by the CPU of the chip module 6 to display content. To describe in further detail, the chip module 6 (e.g., the CPU) first generates display data based on the EDID that is included in the EDID dataset obtained in step S6, and then sends the display data to the display 51 through the interface-chip connection so that the display 51 displays content based on the display data.

In step S8, in response to determining that the EDID lock setting is disabled in step S2, the MCU 1 notifies (e.g., through an HPD signal) the chip module 6 that the display 51 has been connected, and the flow proceeds to step S9. To describe in further detail, the MCU 1 generates the first control signal to indicate the interface-chip connection between the IO interface 25 and the chip module 6, and sends the first control signal to the first multiplexer 3. In response to receiving the first control signal that indicates the interface-chip connection, the first multiplexer 3 establishes the interface-chip connection between the IO interface 25 and the chip module 6. After sending the first control signal to the first multiplexer 3, the MCU 1 notifies the chip module 6 that the display 51 has been connected to the respective one of the connection ports.

In step S9, in response to being notified by the MCU 1, the chip module 6 obtains the EDID from the display 51 through the interface-chip connection, and the flow proceeds to step S10.

In step S10, the chip module 6 controls, through the interface-chip connection, the display 51 to display content based on the EDID. In this embodiment, step S10 is performed in a similar manner as step S7, and will not be described in further detail for the sake of brevity.

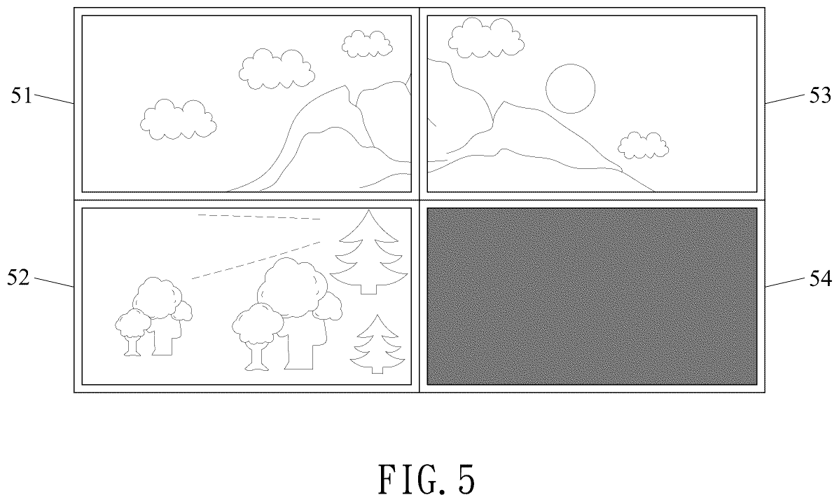

In summary, according to the disclosure, when the EDID lock setting is enabled, the MCU 1 stores the EDID of each of the displays 51-54 into the corresponding one of the storage mediums 21-24, and interlocks each EDID with its corresponding one of the displays 51-54. In a case where the CPU of the chip module 6 is unable to interlock each EDID with its corresponding display (e.g., when the CPU is not from a specific brand), the MCU 1 is still able to notify the chip module 6 of which EDID corresponds to which one of the displays 51-54. As such, the interlocking of the EDID and its corresponding display may still be achieved regardless of the brand of the CPU of the chip module 6. In one example, assuming that the display 54 is disconnected from the IO interface 25, the chip module 6 is still able to obtain the EDID of the displays 51-53 from the storage mediums 21-23, respectively, with the assist of the MCU 1, and thus the displays 51-53 may still display content correctly based on the display data received from the chip module 6 as exemplified in FIG. 5.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of managing extended display identification data (EDID) to be implemented by a management apparatus that is adapted to be connected to a chip module and a display, the management apparatus including a microcontroller (MCU), an input/output (IO) interface and a storage medium, the IO interface including a connection port that is adapted to be connected to the display and that is associated with the storage medium, the display storing EDID related to itself, the method comprising steps of:
the MCU obtaining the EDID from the display;
in response to obtaining the EDID, the MCU storing the EDID in the storage medium that is associated with the connection port which the display is connected to; and
after storing the EDID in the storage medium, the MCU generating and sending a notification signal to the chip module, where the notification signal is related to the storage medium, so that the chip module obtains the EDID from the storage medium based on the notification signal, and controls the display that corresponds to the storage medium to display content based on the EDID.

2. The method as claimed in claim 1, an EDID lock setting being preset to be one of enabled and disabled, the method further comprising, before the step of the MCU obtaining the EDID, steps of:
the MCU receiving a connection signal from the IO interface that outputs the connection signal upon the display being connected to the connection port;
in response to receiving the connection signal, the MCU identifying the connection port that is connected to the display based on the connection signal, and determining whether the EDID lock setting is enabled; and
in response to determining that the EDID lock setting is enabled, the MCU performs the step of the MCU obtaining the EDID.

3. The method as claimed in claim 2, the management apparatus further including a first multiplexer electrically connected among the MCU, the IO interface and the chip module, wherein the step of the MCU obtaining the EDID includes:
the MCU generating a first control signal to indicate an interface-MCU connection between the IO interface and the MCU, and sending the first control signal to the first multiplexer;
in response to receiving the first control signal that indicates the interface-MCU connection, the first multiplexer establishing the interface-MCU connection between the IO interface and the MCU; and
the MCU obtaining the EDID from the display through the interface-MCU connection.

4. The method as claimed in claim 3, the management apparatus further including a second multiplexer electrically connected among the MCU, the storage medium and the chip module, wherein the step of the MCU storing the EDID includes:
the MCU generating a second control signal to indicate an MCU-storage connection between the MCU and the storage medium, and sending the second control signal to the second multiplexer;
in response to receiving the second control signal that indicates the MCU-storage connection, the second multiplexer establishing the MCU-storage connection between the MCU and the storage medium; and
the MCU generating an EDID dataset to include the EDID and an address of the storage medium that is associated with the connection port indicated by the connection signal, and transmitting the EDID dataset to the storage medium according to the address through the MCU-storage connection, so as to store the EDID dataset in the storage medium.

5. The method as claimed in claim 4, wherein the step of the MCU generating and sending a notification signal to the chip module includes:
after storing the EDID dataset in the storage medium, the MCU generating the second control signal to indicate a storage-chip connection between the storage medium and the chip module, sending the second control signal to the second multiplexer, generating the first control signal to indicate an interface-chip connection between the IO interface and the chip module, and sending the first control signal to the first multiplexer;
in response to receiving the second control signal that indicates the storage-chip connection, the second multiplexer establishing the storage-chip connection between the storage medium and the chip module;
in response to receiving the first control signal that indicates the interface-chip connection, the first multiplexer establishing the interface-chip connection between the IO interface and the chip module; and
after sending the first control signal and the second control signal to the first multiplexer and the second multiplexer, the MCU generating and sending the notification signal to the chip module, so that the chip module obtains the EDID dataset that is stored in the storage medium based on the notification signal through the storage-chip connection, and controls, through the interface-chip connection, the display that is connected to the connecting port, which corresponds to the storage medium, to display the content.

6. The method as claimed in claim 5, to be implemented further by the chip module, the method further comprising steps of:
the chip module generating display data based on the EDID dataset; and
the chip module sending the display data to the display through the interface-chip connection so that the display displays the content based on the display data.

7. The method as claimed in claim 3, further comprising:
in response to determining that the EDID lock setting is disabled, the MCU generating the first control signal to indicate an interface-chip connection between the IO interface and the chip module, and sending the first control signal to the first multiplexer;
in response to receiving the first control signal that indicates the interface-chip connection, the first multiplexer establishing the interface-chip connection between the IO interface and the chip module; and
after sending the first control signal to the first multiplexer, the MCU notifying the chip module that the display has been connected, so that the chip module obtains the EDID from the display through the interface-chip connection, and controls, through the interface-chip connection, the display to display the content based on the EDID.

8. The method as claimed in claim 7, to be implemented further by the chip module, the method further comprising steps of:
the chip module generating display data based on the EDID; and
the chip module sending the display data to the display through the interface-chip connection so that the display displays the content based on the display data.

9. A management apparatus for managing extended display identification data (EDID), adapted to be connected to a chip module and a display that stores EDID related to itself, the management apparatus comprising:
a storage medium;
an input/output (IO) interface including a connection port that is adapted to be connected to the display and that is associated with said storage medium; and
a microcontroller (MCU) configured to
obtain the EDID from the display,
in response to obtaining the EDID, store the EDID in said storage medium that is associated with said connection port which the display is connected to, and
after storing the EDID in said storage medium, generate and send a notification signal to the chip module, where the notification signal is related to said storage medium, so that in response to receiving the notification signal from said MCU, the chip module obtains the EDID from said storage medium based on the notification signal, and controls the display that corresponds to said storage medium to display content based on the EDID.

10. The management apparatus as claimed in claim 9, an EDID lock setting being preset to be one of enabled and disabled, wherein said MCU is further configured to, before obtaining the EDID:
receive a connection signal from said IO interface that outputs the connection signal upon the display being connected to said connection port; in response to receiving the connection signal, identify said connection port that is connected to the display based on the connection signal, and determine whether the EDID lock setting is enabled; and
in response to determining that the EDID lock setting is enabled, obtain and store the EDID, and send the notification signal to the chip module so that the chip module obtains the EDID from said storage medium and controls the display to display the content based on the EDID.

11. The management apparatus as claimed in claim 10, further comprising a first multiplexer that is electrically connected among said MCU, said IO interface and the chip module, wherein:
said MCU is further configured to generate a first control signal to indicate an interface-MCU connection between said IO interface and said MCU, and send the first control signal to said first multiplexer;
said first multiplexer is configured to, in response to receiving the first control signal that indicates the interface-MCU connection, establish the interface-MCU connection between said IO interface and said MCU; and
said MCU is further configured to obtain the EDID from the display through the interface-MCU connection.

12. The management apparatus as claimed in claim 11, further comprising a second multiplexer that is electrically connected among said MCU, said storage medium and the chip module, wherein:
said MCU is further configured to generate a second control signal to indicate an MCU-storage connection between said MCU and said storage medium, and send the second control signal to said second multiplexer;
said second multiplexer is configured to, in response to receiving the second control signal that indicates the MCU-storage connection, establish the MCU-storage connection between said MCU and said storage medium; and
said MCU is further configured to generate an EDID dataset to include the EDID and an address of said storage medium that is associated with said connection port indicated by the connection signal, and transmit the EDID dataset to said storage medium according to the address through the MCU-storage connection, so as to store the EDID dataset in said storage medium.

13. The management apparatus as claimed in claim 12, wherein:
said MCU is further configured to, after storing the EDID dataset in said storage medium, generate the second control signal to indicate a storage-chip connection between said storage medium and the chip module, send the second control signal to said second multiplexer, generate the first control signal to indicate an interface-chip connection between said IO interface and the chip module, and send the first control signal to said first multiplexer;
said second multiplexer is further configured to, in response to receiving the second control signal that indicates the storage-chip connection, establish the storage-chip connection between said storage medium and the chip module;
said first multiplexer is further configured to, in response to receiving the first control signal that indicates the interface-chip connection, establish the interface-chip connection between said IO interface and the chip module; and
said MCU is further configured to, after sending the first control signal and the second control signal to said first multiplexer and said second multiplexer, generate and send the notification signal to the chip module, so that the chip module obtains the EDID dataset that is stored in said storage medium based on the notification signal through the storage-chip connection, and controls, through the interface-chip connection, the display to display based on the EDID.

14. The management apparatus as claimed in claim 11, wherein:
said MCU is further configured to, in response to determining that the EDID lock setting is disabled, generate the first control signal to indicate an interface-chip connection between said IO interface and the chip module, and send the first control signal to said first multiplexer;
said first multiplexer is configured to, in response to receiving the first control signal that indicates the interface-chip connection, establish the interface-chip connection between said IO interface and the chip module; and
said MCU is further configured to, after sending the first control signal to said first multiplexer, notify the chip module that the display has been connected, so that the chip module obtains the EDID from the display through the interface-chip connection, and controls the display to display the content through the interface-chip connection.

15. The management apparatus as claimed in claim 9, wherein said MCU stores a processing program that, when executed, causes said MCU to perform one of:
an overwriting procedure for deleting data from said storage medium, and then storing an EDID dataset in said storage medium; and
a locking procedure for preventing data stored in said storage medium from being tampered with.

16. The management apparatus as claimed in claim 15, wherein said MCU is configured to store the EDID dataset in said storage medium by performing the overwriting procedure and the locking procedure.

17. The management apparatus as claimed in claim 9, wherein said MCU stores a processing program that, when executed, causes said MCU to perform a reading procedure for reading data from said storage medium.
